(19) United States
(12) Patent Application Publication
(10) Pub. No.: US 2014/0152959 A1
(43) Pub. Date: Jun. 5, 2014

(54) ECLIPSE ILLUMINATION COMBINED WITH COAXIAL RED REFLEX ILLUMINATION

(71) Applicant: Leica Microsystems (Schweiz) AG, Heerbrugg (CH)

(72) Inventors: Manfred Kuster, Widnau (CH); Carlo Spizuoco, Rozzano (IT)

(21) Appl. No.: 14/088,488

(22) Filed: Nov. 25, 2013

(30) Foreign Application Priority Data
Nov. 30, 2012 (DE) 10 2012 221 955.2

(51) Int. Cl. G02B 21/10

(52) U.S. Cl. CPC G02B 21/10
USPC 351/221

(57) ABSTRACT

The present invention relates to an illumination device for a surgical microscope, comprising at least one light source (10, 20) for generating a first illumination beam path (80) that makes available a first illumination region in an object plane (70), and a second illumination beam path (90) that makes available a second illumination region in the object plane (70), such that the first illumination region and second illumination region at least partly overlap, and comprising a switching device (50) with which illumination of the object plane with the first and/or with the second illumination beam path (80, 90) can selectably be made available, and an eclipse filter (40), introducible into the first illumination beam path (80), by means of which the first illumination beam part (80) is partly darkenable.

### CROSS REFERENCE TO RELATED APPLICATIONS

This application claims priority of German patent application number 10 2012 221 955.2 filed Nov. 30, 2012, the entire disclosure of which is incorporated by reference herein.

### FIELD OF THE INVENTION

The present invention relates to an illumination device for a surgical microscope, and to a corresponding surgical microscope.

### BACKGROUND OF THE INVENTION

When surgical microscopes are used in ophthalmic surgery, in particular in a cataract extraction, the angle between the illumination axis and the observation axis of the microscope is to be kept as small as possible. The advantage of this type of illumination is that the light beams incident perpendicularly onto the eye are reflected diffusely by the retina, and the lens capsule of the eye is thereby visible in a reddish transmitted light. This effect is also referred to as the “red reflex.” The quality of this red reflex is crucially important in cataract extraction. In this procedure, all tissue residues must be removed from the eye after the lens is removed. This can be done only if these tissue residues are visualized with sufficient optical contrast.

On the other hand, what is necessary during the procedure is not only red-reflex visualization but also conventional illumination, in order to illuminate the entire surgical field. This illumination of the entire surgical field (called “main” or “ambient” illumination) is necessary, for example, in connection with the introduction of instruments into the surgical area or also in order to carry out surgical steps in the vicinity. In this context the red-reflex illumination should preferably be switched off for reasons of patient safety.

Cornea transplantation surgery may be mentioned as an example of a typical procedure in the surgical field surrounding the red reflex region.

EP 0 661 020 B1 discloses a switchable illumination device for a surgical microscope. With this illumination device it is possible to make available, individually or together, a red-reflex illumination or a Köhler illumination constituting the main or ambient illumination.

DE 101 08 254 A1 discloses a microscope comprising one light source providing one illumination beam path, into which an optical filter comprising regions of higher optical transmittance and lower optical transmittance can be inserted.

The aim of the invention is a flexible illumination system for a surgical microscope with which both red reflex and main illumination modes can be optimally provided and coordinated with one another.

### SUMMARY OF THE INVENTION

This goal is achieved with an illumination device having the features described in the present specification.

According to the present invention, enhanced flexibility (as compared with the prior art) in terms of illumination is provided for a surgical microscope. For example, according to the present invention it is easily possible to make available exclusively red-reflex or coaxial illumination, complete object field illumination (main illumination) including illumination of the close-to-axis region of the object field, main illumination without illumination of the close-to-axis part of the object field, red-reflex illumination together with main illumination including illumination of the close-to-axis region of the object field, and red-reflex illumination with main illumination with no illumination of the close-to-axis regions of the object field.

The operating mode in which red-reflex illumination is used together with main illumination without illumination of the close-to-axis regions (i.e. the close to axis regions not being illuminated by the main illumination but only by the red-reflex illumination) proves in particular to be very advantageous, since the red reflex is visible with simultaneous illumination of the surroundings, but the main-illumination light has no obtrusive contrast-reducing influence on the red reflex.

The term “eclipse filter”, as used in the present context, shall mean an optical filter comprising a (first) region of high optical transmittance and a (second) region of low optical transmittance. Preferably, the first region is essentially transparent, and the second region essentially opaque. For example, the first region can be provided with a optical transmittance of 90%-100%, especially 90%, 95%, 96%, 97%, 98% or 99% for light of the visible spectrum or for light of specific frequencies or frequency bands, for example suitable bands within the region of 400-800 nm especially from 420-470 nm 470-600 nm, 600-700 nm or 700-800 nm. The second region can be provided with a optical transmittance of 0%-20%, especially 0%, 1%, 2%, 3%, 4%, 5%, 6%, 7%, 8%, 9%, 10%, 15% or 20%. Preferably, it has an optical transmittance of 0%, i.e. is essentially opaque.

The arrangement of the first and second region to one another can be chosen as expedient for a specific purpose. It is especially preferable to provide an arrangement wherein the second region is provided centrally (i.e. around the central axis of the illumination beam path interacting with the eclipse filter), the first region being arranged around the second region. In case of a circular second region, the first region will preferably be provided as a concentric annular region.

Advantageous embodiments of the invention are described herein.

Expediently, the eclipse filter used according to the present invention, also referred to as a “darkening filter,” is positioned or positionable in a plane of the illumination beam path conjugated with the object plane. The darkening structure made available by the darkening filter can thereby be precisely imaged onto the object field.

It is particularly advantageous to position and/or dimension the eclipse filter in such a way that the darkened region of the first illumination beam path (main illumination) corresponds substantially to the illumination region of the second beam path (coaxial or red-reflex illumination). This provides an optimally illuminated object field to a user of the surgical microscope.

Expediently, the illumination region of the second illumination beam path completely overlaps the darkened region, an overlap edge from 1 mm to 3 mm in particular being provided. This feature allows elimination of a white (unilluminated) ring, which interferes with observation, when the eclipse filter is used.

Expediently, the eclipse filter is selectably introducible into and removable from the first illumination beam path.

It proves to be advantageous to provide a controllable transmittance of the eclipse filter. A particularly flexible illumination intensity, in particular of a central region of the object field, can thereby be made available.

It is preferred for the first illumination beam path and the second illumination beam path to be provided concentrically with one another in the object plane.

It is particularly preferred for the first illumination beam path to be an ambient or main illumination, and for the second illumination beam path to be a coaxial or red-reflex illumination (also referred to as “zero-degree” illumination).

Further advantages and embodiments of the invention will become apparent from the description and the appended drawings.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment, and will be described in detail below with reference to the drawings.

### BRIEF DESCRIPTION OF THE DRAWING VIEWS

In the drawings:

FIG. 1 shows a first illumination mode implementable with an illumination device according to the present invention,

FIG. 2 shows a second illumination mode implementable with an illumination device according to the present invention,

FIG. 3 shows a third illumination mode implementable with an illumination device according to the present invention, and

FIG. 4 shows a fourth illumination mode implementable with an illumination device according to the present invention.

### DETAILED DESCRIPTION OF THE INVENTION

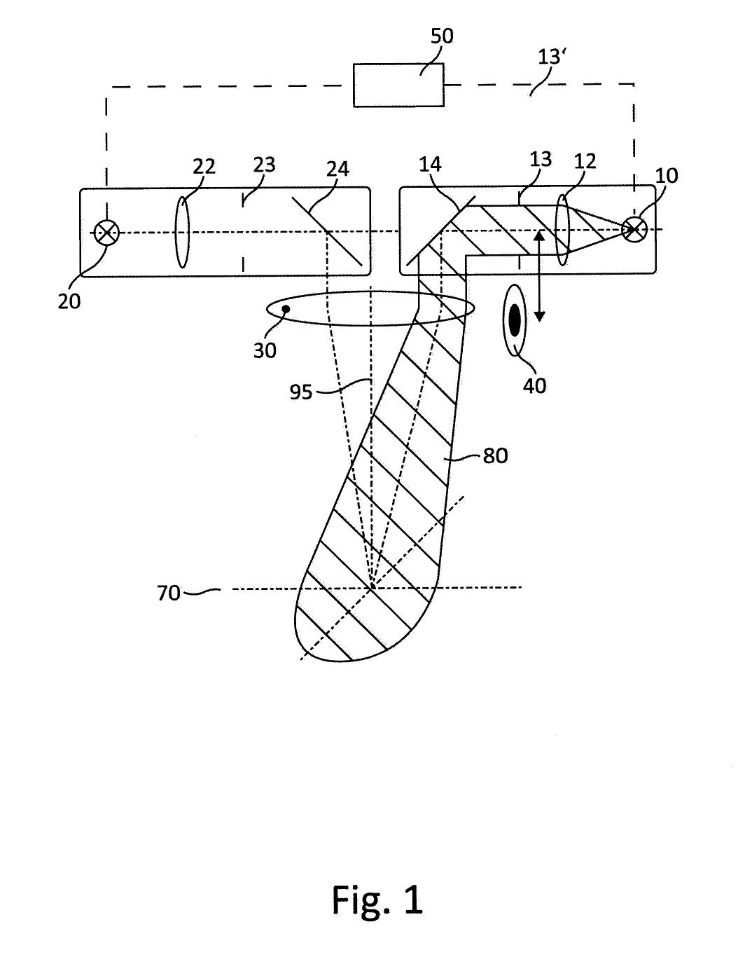

FIGS. 1 to 4 each show sectioned views through the illumination beam path or paths of an illumination device according to the present invention, in different illumination modes.

The preferred embodiment of the illumination device which is depicted comprises a first light source 10 whose light, as a first illumination beam path 80, is guided via an optical system 12 that comprise a collector lens system, a field diaphragm 13, a deflection element 14, and a main objective 30 into an object plane 70. Field diaphragm 13 is preferably arranged in a plane 13′ conjugated with the object plane. The first illumination beam path that is depicted is provided as a Köhler illumination beam path, field diaphragm 13 being imaged through the downstream optical system (here, main objective 30) into object plane 70.

By means of light of first illumination beam path 80, the object or object plane 70 can be observed as a bright image via observation beam path 95 of the microscope (not depicted further). The first illumination beam path thus represents a main illumination.

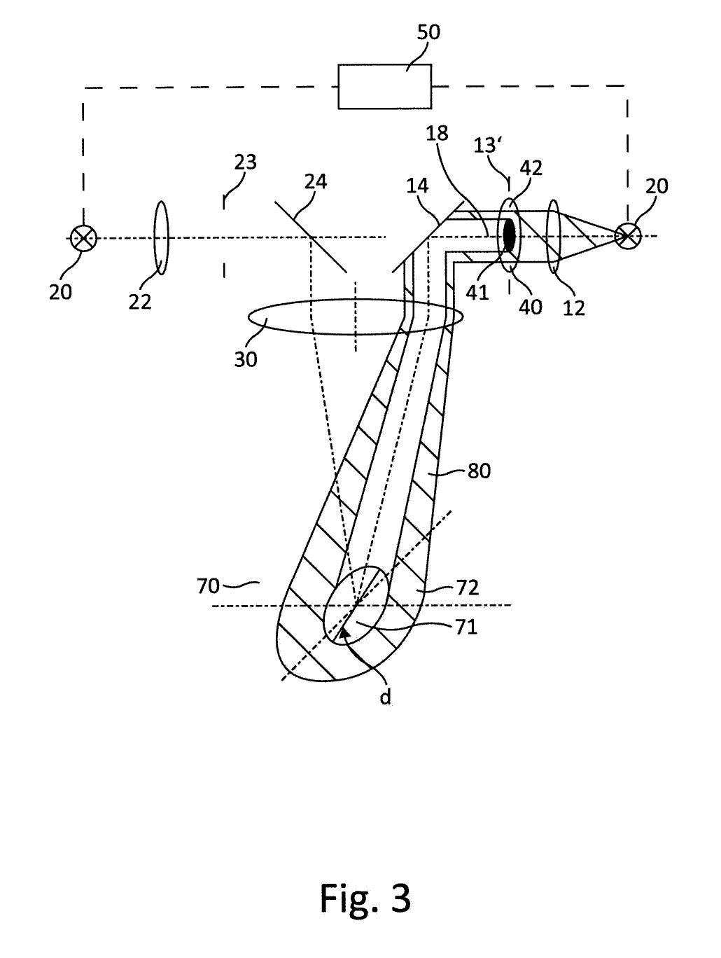

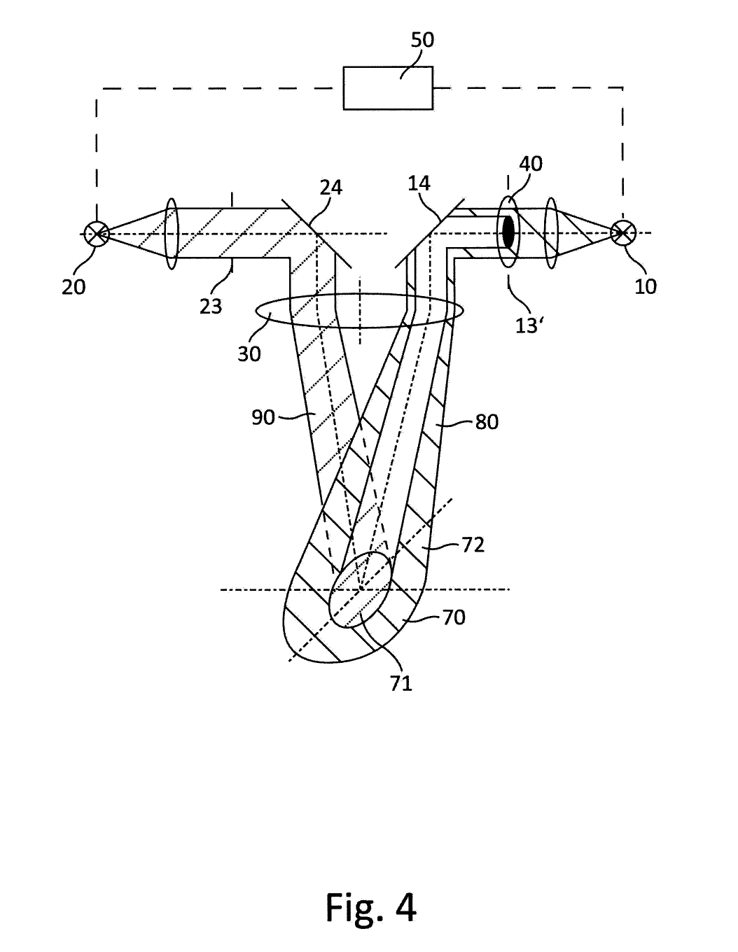

Associated with first illumination beam path 80, but not yet introduced into first illumination beam path 80 in FIG. 1, is an eclipse filter or darkening filter 40 with which first illumination beam path 80 can be partly darkened. This eclipse filter 40 is expediently introduced into first illumination beam path 80 in the plane of field diaphragm 13, as further explained below with reference to FIGS. 3 and 4.

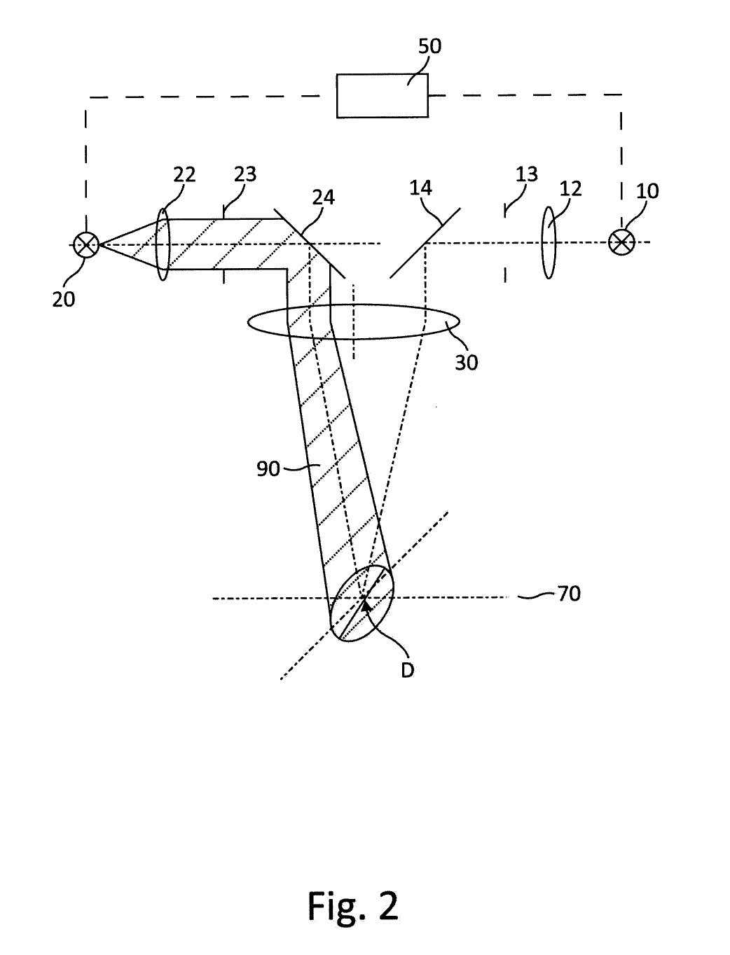

The illumination device according to the present invention furthermore comprises a second light source 20 in order to provide a second illumination beam path 90 (see in particular FIG. 2). The light of light source 20 is once again guided into object plane 70 through an optical system 22 having a collector lens system, a field diaphragm 23 and a deflector element 24, and main objective 30. Second illumination beam path 90 represents a coaxial illumination with which a red reflex can be generated on the retina of an eye being observed.

The illumination device comprises a switching device, depicted schematically and labeled 50, with which the first and the second light source can be selectably switched on and shut off. In particular, with switching device 50 the two light sources can be switched on simultaneously.

According to the present invention, first illumination beam path 80 and second illumination beam path 90 are usable selectably and in differentiated form, as described below:

FIG. 1 depicts a first illumination mode in which illumination of object plane 70 exclusively by means of first illumination beam path 80 is provided. Second illumination beam path 90 is shut off or blocked in this context. This is a conventional main illumination or Köhler illumination.

FIG. 2 depicts, as a second illumination mode, illumination of object plane 70 exclusively with second illumination beam path 90. First illumination beam path 80 here is completely blocked or shut off

In this mode, second illumination beam path 90 represents an exclusively coaxial or red-reflex illumination. Because first illumination beam path 80 is shut off in this context, flare effects on the red reflex can be avoided, with the overall result that a very high-contrast red reflex can be provided.

FIG. 3 once again, correspondingly to FIG. 1, depicts an illumination mode using exclusively first illumination beam path 80; here, unlike in the operating mode according to FIG. 1, eclipse filter 40 is introduced into the first illumination beam path in plane 13 conjugated with object plane 70. It is assumed by way of example that this eclipse filter 40 comprises an opaque region 41 embodied concentrically around optical axis 18 of the first illumination beam path and, surrounding that region, a transparent annular region 42.

Introduction of an eclipse filter 40 of this kind into first illumination beam path 80 produces an unilluminated (darkened) central region 71 in object plane 70. This central region is surrounded by an annular illumination region 72.

Lastly, FIG. 4 depicts an operating mode of the illumination device in which both the first and the second illumination beam paths 80, 90 are switched on. Eclipse filter 40 is once again introduced into first illumination beam path 80.

In object plane 70, the second, outer illumination region 72 corresponds to the one according to FIG. 3. Inner illumination region 70, on the other hand, is not entirely darkened as shown in FIG. 3, but instead is illuminated by means of second illumination beam path 90. With this feature an optimum red reflex can be ensured by means of second illumination beam path 90, since flare on the retina as a result of first illumination beam path 80 can be avoided. At the same time, it is possible to minimize the illumination intensity of second illumination beam path 90 independently of first illumination beam path 80, in order to minimize stress on or damage to the patient's retina.

Expediently, the diameter D of second illumination beam path 90 in object plane 70 is somewhat larger than the diameter d of darkened region 71; overall, an annular overlap region having a radius from approximately 1 mm to 3 mm is preferred. It is thereby possible to entirely eliminate an unilluminated ring, which is bothersome to a surgeon, in the transition region between the first and the second illumination beam path.

As a further embodiment, both the diameter of field diaphragm 13 of illumination beam path 80 and/or field diaphragm 23 of second illumination beam path 90, as well as the diameter of eclipse filter 40, can be embodied variably.

By means of an additional coupling of these components (field diaphragm 13 and/or 23 and eclipse filter 40), the diameter of the first and/or second illumination beam path can be modified by the surgeon, in which context the overlap region as described above can furthermore be ensured and/or varied.

The embodiment according to FIG. 4 is notable in particular for the fact that the illumination intensities of the first and the second illumination beam path can be adjusted and modified independently of one another.

Be it noted for the sake of completeness that simultaneous complete illumination with the first and the second observation beam path, i.e. without introduction of darkening filter 40 into the first illumination beam path, is also possible.

### Parts List

10 First light source
12 Optical system
13 Field diaphragm
13′ Plane of field diaphragm
14 Deflection element
20 Second light source
22 Optical system
23 Field diaphragm plane
24 Deflection element
30 Main objective
40 Eclipse filter or darkening filter
41 Opaque region of 40
42 Transparent region of 40
50 Switching device
70 Object plane
71 Central region of 70
72 Annular region of 70
80 First illumination beam path
90 Second illumination beam path
95 Observation beam path

What is claimed is:

1. An illumination device for a surgical microscope, the illumination device comprising:
a first light source (10) for generating a first illumination beam path (80) that provides a first illumination region in an object plane (70);
a second light source (20) for generating a second illumination beam path (90) that provides a second illumination region in the object plane (70), wherein the first illumination region and the second illumination region at least partly overlap;
a switching device (50) operable to control the first light source (10) and the second light source (20), whereby illumination of the object plane (70) with the first illumination beam path (80) and/or with the second illumination beam path (90) can selectably be provided; and
an eclipse filter (40) introducible into the first illumination beam path (80) for partially darkening the first illumination beam path (80).

2. The illumination device according to claim 1, wherein the eclipse filter (40) is positionable in a plane (13′) of the first illumination beam path (80) which is conjugated with the object plane (70).

3. The illumination device according to claim 1, wherein the eclipse filter (40) is positionable to provide a darkened region of the first illumination beam path (80) in the object plane (70) corresponding substantially to the second illumination region provided by the second illumination beam path (90).

4. The illumination device according to claim 1, wherein the eclipse filter (40) is positionable to provide a darkened region of the first illumination beam path (80) in the object plane (70), and wherein the second illumination region provided by the second illumination beam path (90) completely overlaps the darkened region of the first illumination beam path (80).

5. The illumination device according to claim 4, wherein the second illumination region defines an annular overlap region surrounding the darkened region.

6. The illumination device according to claim 5, wherein the annular overlap region has a radius in a range from 1 mm to 3 mm.

7. The illumination device according to claim 1, wherein the eclipse filter has a variable diameter.

8. The illumination device according claim 1, wherein at least one of the first illumination beam path (80)and the second illumination beam path (90) has an illuminated field diameter that is variable.

9. The illumination device according to claim 6, wherein the second illumination beam path (90) has an illuminated field diameter that is variable and the eclipse filter has a variable diameter, wherein the illuminated field diameter of the second illumination beam path (90) and the diameter of the eclipse filter (40) can be varied in controlled fashion to maintain the radius of the annular overlap region in a range from 1 to 3 mm.

10. The illumination device according to claim 1, wherein the eclipse filter (40) is selectably introducible into and removable from the first illumination beam path (80).

11. The illumination device according to claim 1, wherein the eclipse filter (40) has a controllable light transmittance.

12. The illumination device according to claim 1, wherein the first illumination region provided by the first illumination beam path (80) and the second illumination region provided by the second illumination beam path (90) are concentric with respect to one another in the object plane (70).

13. The illumination device according to claim 1, wherein the first illumination beam path (80) provides a main illumination, and the second illumination beam path provides a coaxial or red-reflex illumination.

14. A surgical microscope comprising:
an observation beam path (95);
an object plane (70) observable via the observation beam path (95);
a first light source (10) for generating a first illumination beam path (80) that provides a first illumination region in the object plane (70);
a second light source (20) for generating a second illumination beam path (90) that provides a second illumination region in the object plane (70), wherein the first illumination region and the second illumination region at least partly overlap;
a switching device (50) operable to control the first light source (10) and the second light source (20), whereby illumination of the object plane (70) with the first illumination beam path (80) and/or with the second illumination beam path (90) can selectably be provided; and
an eclipse filter (40) introducible into the first illumination beam path (80) for partially darkening the first illumination beam path (80).
